(19) United States
(12) Patent Application Publication
(10) Pub. No.: US 2011/0152064 A1
(43) Pub. Date: Jun. 23, 2011

(54) PROCESSING OF HIGH SURFACE AREA OXIDES

(75) Inventors: Hrishikesh Keshavan, Clifton Park, NY (US); Dan Hancu, Clifton Park, NY (US); Benjamin Hale Winkler, Albany, NY (US)

(73) Assignee: GENERAL ELECTRIC COMPANY, Schenectady, NY (US)

(21) Appl. No.: 12/640,109

(22) Filed: Dec. 17, 2009

(51) Int. Cl. B01J 29/04

(52) U.S. Cl. 502/62; 502/60

(57) ABSTRACT

A method for coating a support with a catalyst powder is provided. The method includes preparing a slurry by mixing a catalyst precursor, substrate precursor, a templating agent and a surfactant, spray drying the slurry into a powder and calcing the powder to produce a treated powder. Another slurry is created using the treated powder and a liquid medium, such as isopropyl alcohol. A second catalytic material is added to this slurry to form a washcoat. The washcoat is applied to a support, dried and repeated until a desired amount of powder is applied to the support. The support is then calcined.

### TECHNICAL FIELD

The systems and techniques described include embodiments that related to the manufacture of catalysts. They further include embodiments that related to coating articles with catalysts.

### DISCUSSION OF RELATED ART

Exhaust streams generated by the combustion of fossil fuels, such as in furnaces, ovens, and engines, contain various potentially undesirable combustion products including nitrogen oxides (NOₓ), unburned hydrocarbons (HC), and carbon monoxide (CO). NOₓ, though thermodynamically unstable, may not spontaneously decompose in the absence of a catalyst. Exhaust streams may employ exhaust treatment devices to remove NOₓ and other undesirable products from the exhaust stream.

One type of exhaust treatment device is a catalytic converter. Catalytic converters can include devices using various catalyst systems such as three-way catalysts, oxidation catalysts, selective catalytic reduction (SCR) catalysts, and the like. Such catalyst systems generally involved, among other steps, passing the exhaust gas or other gas to be treated over a catalytically active surface. In order to have a more effective conversion, it is generally desirable to create a large active surface area in the catalytic converter in order to have a large number of sites for the catalytic process to occur.

The active surface is generally either a catalytic material that itself is formed in a way to provide a high surface area, or a catalytic coating that is disposed upon a substrate that has a high surface area, such as a porous substrate. It is desirable to form the catalyst, or coat the substrate with the catalyst, in a manner that minimizes any chemical alteration to the catalyst or that reduces the effectiveness of the catalytic material, especially when the catalyst is a highly reactive material, such as silver.

Therefore, there is an ongoing need for continued development of techniques and compositions for high-surface area catalytic materials.

### BRIEF DESCRIPTION

In accordance with an aspect of the techniques described herein, a support structure is coated using a coating slurry. The coating slurry is prepared by mixing a catalyst precursor, a substrate precursor, a templating agent and a surfactant to form a precursor slurry. This slurry is spray dried to form a precursor powder. The precursor powder is calcined in a controlled atmosphere to form a treated powder. A volume of liquid medium is added to the treated powder to form an intermediate slurry. A volume of zeolite is added to the intermediate slurry to form a coating slurry, such that the zeolite remains free of any ion transfer from the catalyst precursor in the intermediate slurry. The support is then wetted with, for example by being dipped into or spray coated with, the coating slurry, and then air is blown over the surface of the support monolith to evaporate the alcohol from the coating slurry and leave a coating of the treated powder on the monolith. The wetting, blowing and drying steps may be repeated until a desired thickness of the treated powder has been deposited on the monolith. The monolith is then re-calcined in air.

In accordance with an aspect of a product as taught herein, the product is formed via the coating of a support structure with a coating slurry. The coating slurry is prepared by mixing a catalyst precursor, a substrate precursor, a templating agent and a surfactant to form a precursor slurry. This slurry is spray dried to form a precursor powder. The precursor powder is calcined in a controlled atmosphere to form a treated powder. A volume of liquid medium is added to the treated powder to form an intermediate slurry. A volume of zeolite is added to the intermediate slurry to form a coating slurry, such that the zeolite remains free of any ion transfer from the catalyst precursor in the intermediate slurry. The support is then wetted with, for example by being dipped into or spray coated with, the coating slurry, and then air is blown over the surface of the support monolith to evaporate the alcohol from the coating slurry and leave a coating of the treated powder on the monolith. The wetting, blowing and drying steps may be repeated until a desired thickness of the treated powder has been deposited on the monolith. The monolith is then re-calcined in air.

### DETAILED DESCRIPTION

As noted above, ongoing efforts to reduce pollutants in the exhaust of combustion systems have resulted in the development of a variety of catalysts and treatment systems using those catalysts. One particular catalyst system that has been shown effective for the reduction of NOx emissions is the use of silver with templated alumina. One such technique is described in U.S. patent application Ser. No. 12/123,070 entitled “CATALYST AND METHOD OF MANUFACTURE”, the entirety of which is hereby incorporated by reference herein. Other techniques, useful for creation of a mixed-bed catalyst system, are described in U.S. patent application Ser. No. 12/474,873 entitled “CATALYST AND METHOD OF MANUFACTURE”, the entirety of which is hereby incorporated by reference herein.

One particular technique for creating an appropriate catalyst involves preparing a solution of a templated catalyst material, freezing it, and then drying it with a freeze drier. After having any excess organic material removed using a Soxhlet extractor, the material is dried in a vacuum oven. A slurry using this extracted powder is produced, and a suitable substrate is washcoated with the slurry and calcined to form the silver-alumina catalyst.

Although such a process can produce a suitable coated monolith, various portions of the treatment and coating process can reduce the effectiveness of the catalyst material. In particular, some of these processes can induce chemical alterations in the catalyst, while others result in changes to the physical properties of the material, such as changes in particle size or pore size, that can reduce the ability of the catalyst to be fully effective. It may be desirable to minimize the chemical alterations to the catalyst that are introduced during processing, as well as providing an advantageous physical structure in the final product, to provide the most effective NOx reduction capability by the final catalyst. The systems and techniques described herein can provide features such as a high surface area for the catalyst powder, as well as coating materials that allow for uniformly high catalyst loading in the washcoated product.

As used herein, without further qualifiers mesoporous refers to a material containing pores with diameters in a range of from about 2 nanometers to about 50 nanometers. As used herein, a catalyst is a substance that can cause a change in the rate of a chemical reaction without itself being consumed in the reaction. A slurry is a mixture of a liquid and finely divided particles. A sol is a colloidal solution. A powder is a substance including finely dispersed solid particles. Templating refers to a controlled patterning; and, templated refers to determined control of an imposed pattern and may include molecular self-assembly. A monolith may be a ceramic block having a number of channels, and may be made by extrusion of clay, binders and additives that are pushed through a dye to create a structure. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

In one embodiment of a method as described herein for coating a support with a catalytic material, a precursor slurry is prepared by mixing a catalyst precursor, a templating agent and a surfactant. In addition, a co-catalyst or a substrate precursor may also be added to the precursor slurry in particular embodiments. The precursor slurry is spray dried to form a powder of the precursor material. This precursor powder is calcined in order to form a treated powder.

The treated powder is used to prepare a coating slurry that can be used to washcoat a catalyst support, such as a monolith. The coating slurry is prepared by adding a liquid to the powder until a desired thickness is achieved. In particular embodiments, it will be desirable that the liquid added to the powder in creating the slurry has as little chemical effect upon the treated catalyst powder as possible, so as to not alter the catalytic properties of the treated powder. However, it is also desirable that the liquid provide an appropriate medium for the delivery of the catalyst to the support without physically harming the properties of either the catalyst or the support itself. This liquid will be referred to as the “liquid medium” or the “solvent”. Those of skill in the art will appreciate that this use of the term “solvent” for the creation of the slurry is not intended to suggest that the treated powder actually dissolves into the liquid support medium, and in fact it may be desirable that such dissolving is minimized. An alcohol, such as isopropyl alcohol, may be used as the liquid medium in some embodiments to achieve these desired results with particular catalyst materials.

Once the coating slurry is prepared, the support is washcoated with the slurry in order to deposit the treated powder onto the surface of the support. For example, the support may be wetted with the coating slurry, by dipping, spraying or other techniques, to coat the support (or a desired sub-portion of the support) with the coating slurry. Once the coating slurry has been applied to the support, the wetted support is dried, either via dripping or blowing with an appropriate gas in order to remove any excess liquid from the slurry on the support and leave a coating of treated powder behind.

In a particular embodiment of a washcoating process, a monolith or other support is immersed in the coating slurry for a period of time, 30 seconds in an exemplary embodiment. Excess slurry is removed from the support by blowing compressed air, for example at 60 psi, using an air knife for a given time. The monolith may be supported on a rotating spindle. The wet monolith is then dried using hot air. After drying, the sample is considered to be coated once. In one embodiment the number of coatings desired is 3, while in other embodiments, a different number of coatings may be used. The washcoated monolith is calcined in a box furnace at 550 degrees Celsius for 4 hours with a heating rate of about 2 degrees Celsius per minute using air as atmosphere.

This wetting and drying process may be repeated as many times as desired in order to deposit a sufficient coating of treated catalyst powder onto the support.

It should be noted that the process of wetting with the slurry and then drying repeatedly requires repeated exposure of the support to the coating slurry, including exposure to the liquid used to create the coating slurry from the treated powder. The more that the treated powder and/or the support have any reaction to the liquid, the more harm may be done to the chemical or physical properties of the powder during the coating process. Once the desired coating of treated powder is transferred to the support, the coated support may be calcined to further bond the coating to the support.

It will be recognized that there are a variety of different materials that may be used for the components described above. In one particular embodiment, the catalyst precursor may be silver, the templating agent may be ethyl-acetoacetate, the surfactant may be an octylphenol ethoxylate, for example Triton™ X-114 commercially available from Dow Chemicals (Midland, Mich.). A co-catalyst precursor may be aluminum sec-butoxide in some embodiments. In an embodiment, the liquid added to the precursor slurry may be isopropyl alcohol and the coating slurry may be washcoated onto the support with blow drying used to remove excess slurry after each coating. In an embodiment, the final calcination may be performed at about 550 degrees Celsius in air.

Inorganic alkoxides may be used as co-catalyst or substrate precursors in various embodiments. Such inorganic alkoxides may include one or more of tetraethyl ortho silicate, tetramethyl ortho silicate, aluminum isopropoxide, aluminum tributoxide, aluminum ethoxide, aluminum-tri-sec-butoxide, aluminum tert-butoxide, antimony (III) ethoxide, antimony (III) isopropoxide, antimony (III) methoxide, antimony (III) propoxide, barium isopropoxide, calcium isopropoxide, calcium methoxide, chloro triisopropoxy titanium, magnesium di-tert-butoxide, magnesium ethoxide, magnesium methoxide, strontium isopropoxide, tantalum (V) butoxide, tantalum (V) ethoxide, tantalum (V) ethoxide, tantalum (V) methoxide, tin (IV) tert-butoxide, diisopropoxytitanium bis(acetylacetonate) solution, titanium (IV) (triethanolaminato) isopropoxide solution, titanium (IV) 2-ethylhexyloxide, titanium (IV) bis(ethyl acetoacetato)diisopropoxide, titanium (IV) butoxide, titanium (IV) butoxide, titanium (IV) diisopropoxide bis(2,2,6,6-tetramethyl-3,5-heptanedionate), titanium (IV) ethoxide, titanium (IV) isopropoxide, titanium (IV) methoxide, titanium (IV) tert-butoxide, vanadium (V) oxytriethoxide, vanadium (V) oxytriisopropoxide, yttrium (III) butoxide, yttrium (III) isopropoxide, zirconium (IV) bis(diethyl citrato)dipropoxide, zirconium (IV) butoxide, zirconium (IV) diisopropoxidebis(2,2,6,6-tetramethyl-3,5-heptanedionate), zirconium (IV) ethoxide, zirconium (IV) isopropoxide zirconium (IV) tert-butoxide, zirconium (IV) tert-butoxide, or the like. An exemplary inorganic alkoxide is aluminum sec-butoxide.

The slurry, also referred to as the ‘reactive solution’, may contain an inorganic alkoxide in an amount greater than about 1 weight percent based on the weight of the reactive solution. In one embodiment, the reactive solution contains an inorganic alkoxide in an amount in a range of from about 1 weight percent to about 5 weight percent, from about 5 weight percent to about 10 weight percent, from about 10 weight percent to about 15 weight percent, from about 15 weight percent to about 20 weight percent, from about 20 weight percent to about 30 weight percent, from about 30 weight percent to about 40 weight percent, from about 40 weight percent to about 50 weight percent, or greater than about 50 weight percent.

A second catalyst may also be added to the initial precursor slurry if the catalytic action of additional catalysts is desired. Such an additional catalyst precursor may include zeolites in some embodiments, or materials that have been preprocessed to include multiple catalysts.

In other embodiments, suitable catalyst precursors may include catalytic metals such as one or more alkali metals, alkaline earth metals, transition metals, and main group metals. Examples of suitable catalytic metals as precursors are silver, platinum, gold, palladium, iron, nickel, cobalt, gallium, indium, ruthenium, rhodium, osmium, and iridium. In one embodiment, the catalytic metal may include a combination of two or more of the foregoing metals.

The catalytic metals may be present in the catalyst composition in an amount greater than about 0.025 mole percent. The amount selection may be based on end use parameters, economic considerations, desired efficacy, and the like. In addition, various mole percents may be more desirable for particular catalysts. In one embodiment, the amount is in a range of from about 0.025 mole percent to about 0.2 mole percent, from about 0.2 mole percent to about 1 mole percent, from about 1 mole percent to about 5 mole percent, from about 5 mole percent to about 10 mole percent, from about 10 mole percent to about 25 mole percent, from about 25 mole percent to about 35 mole percent, from about 35 mole percent to about 45 mole percent, from about 45 mole percent to about 50 mole percent, or greater than about 50 mole percent. An exemplary amount of catalytic metal in the catalyst composition is about 1.5 mole percent to about 9 mole percent, when the catalytic metal is silver. As will be discussed in greater detail below, silver at about a 4.5 mole percent has been used successfully to create catalytic coatings as described herein.

In various embodiments, the co-catalyst or substrate precursor may include an inorganic material. Suitable inorganic materials may include, for example, inorganic oxides, inorganic carbides, inorganic nitrides, inorganic hydroxides, inorganic oxides, inorganic carbonitrides, inorganic oxynitrides, inorganic borides, or inorganic borocarbides. In one embodiment, the inorganic oxide may have hydroxide coatings. In one embodiment, the inorganic oxide may be a metal oxide. The metal oxide may have a hydroxide coating. Other suitable metal inorganics may include one or more metal carbides, metal nitrides, metal hydroxides, metal carbonitrides, metal oxynitrides, metal borides, or metal borocarbides. Metallic cations used in the foregoing inorganic materials can be transition metals, alkali metals, alkaline earth metals, rare earth metals, or the like.

Examples of suitable inorganic oxides include silica (SiO₂), alumina (Al₂O₃), titania (TiO₂), zirconia (ZrO₂), ceria (CeO₂), manganese oxide (MnO₂), zinc oxide (ZnO), yttrium oxide (Y₂O₃), tungsten oxide (WO₃), iron oxides (e.g., FeO, β-Fe₂O₃, γ-Fe₂O₃, ε-Fe₂O₃, Fe₃O₄, or the like), calcium oxide (CaO), and manganese dioxide (MnO₂ and Mn₃O₄). Examples of suitable inorganic carbides include silicon carbide (SiC), titanium carbide (TiC), tantalum carbide (TaC), tungsten carbide (WC), hafnium carbide (HfC), or the like. Examples of suitable nitrides include silicon nitrides (Si₃N₄), titanium nitride (TiN), or the like. Examples of suitable borides include lanthanum boride (LaB₆), chromium borides (CrB and CrB₂), molybdenum borides (MoB₂, Mo₂B₅ and MoB), tungsten boride (W₂B₅), or the like. An exemplary inorganic substrate is alumina. The alumina may be crystalline or amorphous.

Suitable surfactants for use in creating the templated substrate may include cationic surfactants, anionic surfactants, non-ionic surfactants, or Zwitterionic surfactants. In one embodiment, the substrate precursor may include one or more cyclic species. Examples of such cyclic species may include cyclodextrin and crown ether.

Other surfactants may include, in various embodiments, cetyltrimethyl ammonium bromide (CTAB), cetylpyridinium chloride (CPC), polyethoxylated tallow amine (POEA), benzalkonium chloride (BAC), and benzethonium chloride (BZT). Other suitable cationic surfactants may include those having a chemical structure denoted by CH₃(CH₂)₁₅N(CH₃)₃—Br, CH₃(CH₂)₁₅-(PEO)ₙ—OH where n=2 to 20 and where PEO is polyethylene oxide, CH₃(CH₂)₁₄COOH and CH₃(CH₂)₁₅NH₂. Other suitable cationic surfactants may include one or more fluorocarbon surfactants, such as C₃F₇O(CFCF₃CF₂O)₂CFCF₃—CONH(CH₂)₃N(C₂H₅)₂CH₃I) commercially available as FC-4.

Suitable anionic surfactants may include one or more of sodium dodecyl sulfate (SDS), ammonium lauryl sulfate, alkyl sulfate salts, sodium laureth sulfate also known as sodium lauryl ether sulfate (SLES), alkyl benzene sulfonate, soaps, fatty acid salts, or sodium dioctyl sulfonate (AOT). Suitable Zwitterionic surfactants may include dodecyl betaine, dodecyl dimethylamine oxide, cocamidopropyl betaine, or coco ampho-glycinate.

Nonionic surfactants may have polyethylene oxide molecules as hydrophilic groups. Suitable ionic surfactants may include alkyl poly(ethylene oxide), copolymers of poly(ethylene oxide) and poly(propylene oxide) commercially called Poloxamers or Poloxamines and commercially available under the trade name PLURONICS. Examples of copolymers of poly (ethylene oxide) are (EO)₁₉(PO)₃₉(EO)₁₉, (EO)₂₀(PO)₆₉(EO)₂₀, (EO)₁₃(PO)₃₀(EO)₁₃, poly(isobutylene)-block-poly(ethylene oxide), poly(styrene)-block-poly(ethylene oxide)diblock copolymers, and block copolymer hexyl-oligo(p-phenylene ethynylene)-poly(ethylene oxide). Additional examples for copolymers of poly(ethylene oxide) are shown in the FIG. 1.

Suitable non-ionic surfactants may include one or more alkyl polyglucosides, octylphenol ethoxylate, decyl maltoside, fatty alcohols, cetyl alcohol, oleyl alcohol, cocamide monoethanolamine, cocamide diethanolamine, cocamide triethanolamine, 4-(1,1,3,3-tetramethyl butyl)phenyl-poly(ethylene glycol), polysorbitan monooleate, or amphiphilic poly(phenylene ethylene) (PPE). Suitable poly glucosides may include octyl glucoside. Other suitable non-ionic surfactants may include long-chain alkyl amines, such as primary alkylamines and N,N-dimethyl alkylamines. Suitable primary alkylamines may include dodecylamine and hexadecylamine. Suitable N,N-dimethyl alkylamines may include N,N-dimethyl dodecylamine or N,N-dimethyl hexadecylamine.

The substrate may be mesoporous and have average diameters of pore greater than about 2 nanometers. In one embodiment, the substrate may have average pores sizes in a range of from about 2 nanometers to about 3 nanometers, from about 3 nanometers to about 5 nanometers, from about 5 nanometers to about 7 nanometers, from about 7 nanometers to about 10 nanometers, from about 10 nanometers to about 15 nanometers, from about 15 nanometers to about 17 nanometers, from about 17 nanometers to about 20 nanometers, from about 20 nanometers to about 25 nanometers, from about 25 nanometers to about 30 nanometers, from about 30 nanometers to about 35 nanometers, from about 35 nanometers to about 45 nanometers, from about 45 nanometers to about 50 nanometers, or greater than about 50 nanometers. The average pore size may be measured using nitrogen measurements (BET). An exemplary substrate is a mesoporous substrate.

The pore size may have a narrow monomodal distribution. In one embodiment, the pores have a pore size distribution polydispersity index that is less than about 1.5, less than about 1.3, or less than about 1.1. In one embodiment, the distribution in diameter sizes may be bimodal, or multimodal. The porous materials may be manufactured via a templating process, which will be described below.

The pores may be distributed in a controlled and repeating fashion to form a pattern. In one embodiment, the pore arrangement is regular and not random. The pores may be ordered and may have an average periodicity. The average pore spacing may be controlled and selected based on the surfactant selection that is used during the gelation. In one embodiment, the pores are unidirectional, are periodically spaced, and have an average periodicity. One porous substrate has pores that have a spacing of greater than about 20 Angstroms (Å). In one embodiment, the spacing is in a range of from about 20 Å to about 40 Å, from about 40 Å to about 50, from about 50 Å to about 100 Å, from about 100 Å to about 150 Å, from about 150 Å to about 200 Å, from about 200 Å to about 250 Å, from about 250 Å to about 300 Å, or greater than about 300 Å. The average pore spacing (periodicity) may be measured using small angle X-ray scattering.

The porous substrate may have a surface area greater than about 0.5 m²/gram. In one embodiment, the surface area is in a range of from about 0.5 m²/gram to about 10 m²/gram, from about 10 m²/gram to about 100 m²/gram, from about 100 m²/gram to about 200 m²/gram, or from about 200 m²/gram to about 1200 m²/gram. In one embodiment, the porous substrate has a surface area that is in a range from about 0.5 m²/gram to about 200 m²/gram. In one embodiment, the porous substrate has a surface area in a range of from about 200 m²/gram to about 250 m²/gm, from about 250 m²/gram to about 500 m²/gm, from about 500 m²/gram to about 750 m²/gm, from about 750 m²/gram to about 1000 m²/gm, from about 1000 m²/gram to about 1250 m²/gm, from about 1250 m²/gram to about 1500 m²/gm, from about 1500 m²/gram to about 1750 m²/gm, from about 1750 m²/gram to about 2000 m²/gm, or greater than about 2000 m²/gm. In various embodiments described below, the porous substrate has a surface area that is in a range from about 200 square meters per gram to about 500 square meters per gram.

The porous substrate may be present in the catalyst composition in an amount that is greater than about 50 mole percent. In one embodiment, the amount present is in a range of from about 50 mole percent to about 60 mole percent, from about 60 mole percent to about 70 mole percent, from about 70 mole percent to about 80 mole percent, from about 80 mole percent to about 90 mole percent, from about 90 mole percent to about 95 mole percent, from about 95 mole percent to about 98 mole percent, from about 98 mole percent to about 99 mole percent, from about 99 mole percent to about 99.9975 mole percent, of the catalyst composition.

In one method of manufacturing, the catalyst precursor, substrate precursor and surfactant are mixed in a vessel. In one embodiment, the substrate or co-catalyst precursor is initially in the form of a sol, and is converted to a gel by the sol-gel process. The catalyst precursor may be in the form of a metal salt. The gel is filtered, washed, dried and calcined to yield a solid treated powder that includes the catalyst disposed on a porous substrate. During the calcination process, the metal salt may be reduced to a catalytic metal.

The treated powder includes the catalyst disposed on a porous form of the substrate. In one embodiment, the treated powder after being calcined has a high surface area and a small particle size. The choice and amount of substrate precursor can affect or control the pore characteristics of the powder.

In a particular embodiment, the particle size distribution of the treated powder is such that about 90% of the mass of the powder (also referred to as the “d90” of the powder) is composed of particles having a size less than about 10 microns. Such small particles sizes result in a relatively high surface area for the powder, which may allow it to adsorb gaseous species on its surface, especially moisture.

In addition, because of the higher relative surface area, the viscosity of a dispersed slurry of the treated powder may be higher than would be found in a conventional gamma alumina powder. This may inhibit the preparation of slurries with high solid loadings, such as are traditionally used in vacuum washcoating.

Furthermore, a slurry formed using such a fine powder may be shear-thickening and exhibit an increase in viscosity when subject to shear rates. This may adversely effect the ability to use dip washcoating with such a slurry.

In order to prepare a slurry that is better suited to a particular manufacturing process, it may be desirable to tailor the properties of the slurry to have predetermined properties (such as viscosity) that are more effective for the desired manufacturing process. Viscosity may be modified in some embodiments by either adding deflocculants and/or other viscosity modifiers, which may include dispersants or surfactants. It is desirable that such dispersants or deflocculants should be chemically inert to the catalytic materials, including the catalyst, co-catalyst and any additional catalyst (such as zeolite) that may be present. Viscosity may also be controlled by adding plasticizers or reducing the overall solid-loading of the slurry. The rheology of the slurry may also be altered through the use of these techniques.

The calcination is conducted at temperatures in a range of from about 350 degrees Celsius to about 400 degrees Celsius, from about 400 degrees Celsius to about 500 degrees Celsius, from about 500 degrees Celsius to about 600 degrees Celsius, from about 600 degrees Celsius to about 700 degrees Celsius, from about 700 degrees Celsius to about 800 degrees Celsius, or from about 800 degrees Celsius to about 900 degrees Celsius. In one embodiment, the calcination is conducted at a temperature of between about 550 degrees Celsius and about 650 degrees Celsius. The calcination may be conducted for a time period of from about 10 minutes to about 30 minutes, from about 30 minutes to about 60 minutes, from about 60 minutes to about 1 hour, from about 1 hour to about 10 hours, from about 10 hours to about 24 hours, or from about 24 hours to about 48 hours.

It will be understood that the particular techniques used to produce the appropriate viscosity for manufacturing may vary among different compositions of the powder, different particle and pore sizes of the powder, different choices for the various components of the powder, and for the particular manufacturing process being performed.

For instance, water may sometimes be desirable to use as a solvent to create the coating slurry for washcoating processes, especially to enhance safety in industrial processes. However, the solid-loading of such a water-based slurry may not be sufficient to allow for a rapid washcoating process. That is, because of the lower level of powder carried in the slurry, more repeated coating and drying steps are required to achieve any particular mass of catalyst material being deposited onto a monolith. The addition of a deflocculant, such as about 3 to about 4 weight percent of ammonium polymethacrylate, commercially available as Darvan™-C from R.T. Vanderbilt Company, Inc., can be used to increase the solid-loading of the washcoating slurry and decrease the number of repeated coating and drying steps required to achieve a desired degree of powder deposition on a monolith or other support.

The addition of this deflocculant can have undesirable effects on the powder. For instance, ammonium polymethacrylate reacts with silver and alters the chemical composition of silver-based catalyst powders. Specifically, silver dissolution was found to occur when ammonium polymethacrylate was added, reducing the amount of silver available in the slurry for washcoating.

In an embodiment, alcohols or other alternatives to water may be used as a solvent in forming the required slurries. Such alternatives may include in various embodiments aprotic polar solvents such as propylene carbonate, ethylene carbonate, butyrolactone, acetonitrile, benzonitrile, nitromethane, nitrobenzene, sulfolane, dimethylformamide, N-methylpyrrolidone, acetone or the like. Suitable polar protic solvents may include water, nitromethane, acetonitrile, and short chain alcohols. Suitable short chain alcohols may include one or more of methanol, ethanol, propanol, isopropanol, butanol, or the like. Suitable non polar solvents may include benzene, hexane, toluene, methylene chloride, carbon tetrachloride, hexane, diethyl ether, or tetrahydrofuran. Co-solvents may also be used. Ionic liquids may be used as solvents during gelation. An exemplary solvent in some embodiments is isopropyl alcohol for use with silver. It will be understood that different solvents or liquid media may be appropriate for different catalyst materials or powder compositions.

Solvents may be present in an amount greater than about 0.5 weight percent of the total weight of the slurry. In one embodiment, the amount of solvent present may be in a range of from about 0.5 weight percent to about 1 weight percent, from about 1 to about 3 weight percent, from about 3 weight percent to about 6 weight percent, from about 6 weight percent to about 10 weight percent, from about 10 weight percent to about 20 weight percent, from about 20 weight percent to about 30 weight percent, from about 30 weight percent to about 40 weight percent, from about 40 weight percent to about 50 weight percent, from about 50 weight percent to about 60 weight percent, from about 60 weight percent to about 70 weight percent, from about 70 weight percent to about 90 weight percent, or greater than about 90 weight percent, based on the total weight of the slurry. Selection of the type and amount of solvent may affect or control the amount of porosity generated in the catalyst composition, as well as affect or control other pore characteristics.

Modifiers may be used to control hydrolysis kinetics of the inorganic alkoxides. Suitable modifiers may include one or more ethyl acetoacetate (EA), ethylene glycol (EG), triethanolamine (TA), or the like. In one embodiment, the reactive solution contains a modifier in an amount greater than about 0.1 weight percent, based on the weight of the reactive solution. In one embodiment, the amount of modifier present may be in a range of from about 0.1 weight percent to about 1 weight percent, from about 1 weight percent to about 2 weight percent, from about 2 weight percent to about 3 weight percent, from about 3 weight percent to about 4 weight percent, from about 4 weight percent to about 5 weight percent, or greater than about 5 weight percent.

### EXAMPLES

Testing was performed to determine the ultimate effect of various additives to the slurry, and to determine which additives had most desirable performance. Different solvents for creating the slurry were also tried. Each slurry was created from a treated powder and selected additives and a selected solvent liquid. The base treated powder had a surface area of about 289 square meters per gram, a pore volume of about 0.25 cubic centimeters per gram, and a pore diameter of about 42 Angstroms.

The powder for testing was made using 4.5% molar silver, and Triton X-114 as a surfactant with a weight percent of Triton X-114 versus water of about 54%. The treated powder particles had a d90 of 9.8 microns. This powder is referred to herein as GE-9. The GE-9 treated powder was used in the preparation of a variety of test coating slurries, which could then be coated on to a support, and calcined in air at about 550 degrees Celsius before testing to determine the amount of NOx conversion achieved using each slurry. The details of the preparation of each tested process and composition are described below. Note that the data for Example 1 is based on testing of the powder samples without coating a support (powder was directly tested in a high throughput reactor), while the data for Examples 2-4 is based on testing of coated supports using simulated exhaust reactors. The specifics of each test are described below:

### Example 1

Test Sample 1-1: GE-9 powder alone was calcined and then tested as a control.

Test Sample 1-2: A slurry of GE-9 powder and water was prepared and ultrasonically milled for 5 minutes. The slurry was dried at 80 degrees Celsius and then calcined and tested.

Test Sample 1-3: A slurry of GE-9 powder, water and about 4 weight percent ammonium polymethacrylate was prepared and ultrasonically milled for 5 minutes. The slurry was dried at 80 degrees Celsius and then calcined and tested.

Test Sample 1-4: A slurry of GE-9 powder, water and citric acid with a pH of 7.0 was prepared and ultrasonically milled for 5 minutes. The slurry was dried at 80 degrees Celsius and then calcined and tested.

Test Sample 1-5: A slurry of GE-9 powder, water and citric acid with a pH of 8.0 was prepared and ultrasonically milled for 5 minutes. The slurry was dried at 80 degrees Celsius and then calcined and tested.

Test Sample 1-6: A slurry of GE-9 powder and isopropyl alcohol was prepared and ultrasonically milled for 5 minutes. The slurry was dried at 80 degrees Celsius and then calcined and tested.

Test Sample 1-7: A slurry of GE-9 powder and isopropyl alcohol was prepared. No ultrasonically milling was performed. The slurry was dried at 80 degrees Celsius and then calcined and tested.

Test Sample 1-8: A slurry of GE-9 powder and isopropyl alcohol was prepared and ultrasonically milled for 5 minutes. The slurry was then aged for about 16 hours before being dried at 80 degrees Celsius, calcined and tested.

Test Sample 1-9: A slurry of GE-9 powder, water and citric acid with a pH of 7.0 was prepared and ultrasonically milled for 5 minutes. The slurry was then aged for about 16 hours before being dried at 80 degrees Celsius, calcined and tested.

All powder test samples were calcined together in the same furnace in air at about 1 degree Celsius per minutes to a temperature of about 550 degrees Celsius for 4 hours prior to being tested.

Samples were tested at four different temperatures (about 275, 325, 375 and 425 degrees Celsius), and the results of these NOx conversion tests for each of the powder Test Samples is shown in Table 1 below:

TABLE 1
Effect of processing additives and solvents on NOx conversion

| | | Addi- | Processing | Conversion % | | | |
|---|---|---|---|---|---|---|---|
| Sample | Solvent | tives | change | 275° | 325° | 375° | 425° |
| Sample 1-1 | None | None | None | 26.2 | 51.7 | 67.2 | 56.9 |
| Sample 1-2 | H₂O | None | USM | 24.2 | 52.9 | 71.2 | 58.5 |
| Sample 1-3 | H₂O | Darvan- | USM | 17.7 | 38.9 | 56.0 | 56.1 |
| | | C | | | | | |
| Sample 1-4 | H₂O | Citric | USM | 26.4 | 47.9 | 66.4 | 57.5 |
| | | acid | | | | | |
| | | (7.0) | | | | | |
| Sample 1-5 | H₂O | Citric | USM | 19.6 | 45.2 | 65.3 | 59.3 |
| | | acid | | | | | |
| | | (8.0) | | | | | |
| Sample 1-6 | IPA | None | USM | 25.0 | 53.0 | 70.7 | 56.1 |
| Sample 1-7 | IPA | None | | 25.2 | 53.0 | 69.7 | 57.8 |
| Sample 1-8 | IPA | None | USM; | 21.2 | 45.9 | 60.5 | 56.4 |
| | | | aging | | | | |
| Sample 1-9 | H₂O | Citric | USM; | 26.7 | 50.8 | 68.1 | 56.4 |
| | | acid | aging | | | | |
| | | (7.0) | | | | | |

As can be seen in Table 1, the NOx conversion rate dropped with every additive, with the ammonium polymethacrylate showing the most significant decrease in effectiveness of the NOx conversion. In addition, the use of isopropyl alcohol as the solvent in place of water showed no significant reduction in conversion, and produced a slurry that was more suitable in terms of solid-loading and viscosity for washcoating. In addition, it can be seen that aging the slurry for 16 hours prior to calcining reduced the NOx conversion rate for the IPA-based slurry.

### Example 2

On the basis of these results, further testing was performed. For this test, GE-9 powder and isopropyl alcohol were used to form a slurry with a weight percent of powder of about 25%. The slurry was mixed in a HDPE Nalgene 125 mL container until the slurry turned coal black. This generally took between about 20 and about 40 minutes. A zeolite was added to the slurry and then mixed for 5 more minutes. The slurry was then washcoated onto a monolith before being calcined at 550 degrees Celsius to improve the adhesion of the washcoat to the substrate.

Test Sample 2-1 was made using GE-9 powder as described above, with isopropyl alcohol as the solvent in the slurry. This slurry was ultrasonically milled. The final coated monolith had a catalyst-loading of 240 grams/liter, where the catalyst-loading is defined as the mass of dried powder (including any catalyst, co-catalyst or additional catalyst, such as zeolite) contained within a given volume occupied by the coated support.

Test Sample 2-2 was made in the same way as Sample 2-1, but the catalyst-loading was only 130 grams/liter.

Test Sample 2-3 was made with water as a solvent in the slurry in place of isopropyl alcohol, and citric acid was added before ultrasonically milling. The catalyst-loading was 146 grams/liter.

The monoliths washcoated with each of these samples were tested using a simulated exhaust stream having 300 parts per million NOx, 1600 ppm of carbon (C1) from ultra-low-sulfur diesel, 0 ppm sulfur dioxide, 7% water, 9% oxygen (O₂), and 0 ppm hydrogen. The monoliths were tested at exhaust temperatures of 300, 350, 400 and 450 degrees Celsius. The results are shown in Table 2.

TABLE 2
Performance of washcoated monoliths (NOx conversion percentage)

Temperature
(degrees Celsius)

| Sample | 300 | 350 | 400 | 450 |
|---|---|---|---|---|
| Sample 2-1 | 18.0 | 31.4 | 36.3 | 35.9 |
| Sample 2-2 | 6.8 | 24.5 | 33.8 | 36.8 |
| Sample 2-3 | 5.1 | 17.6 | 23.6 | 26.4 |

Note that at the higher tested temperatures, the IPA-based slurries (Samples 2-1 and 2-2) produced better results than the water-based slurry (Sample 2-3).

Given the improved performance of the IPA-based slurries, several slurry mixes were tested for silver dissolution. This testing was performed filtering the slurry to be tested using a 50 micron filter paper and then centrifuging the filtrate at 5000 rpm for 5 minutes. Hydrochloric acid (1 molar) was then added to the resulting supernatant liquid. When this liquid turns milky upon the adding of the HCl, this shows that silver is present in the solution and has been dissociated from the original powder in the slurry.

In all of the tested examples, water-based slurries showed silver dissolution, but a slurry of GE-9 powder and isopropyl alcohol did not show any dissociation. Therefore, despite comparable effective NOx conversion rates being achieved by some of the alternate slurries (for example, water-based slurries including citric acid), silver was still being leached out of the powder. IPA-based slurries exhibited no leaching of silver under these tests.

The use of IPA as a solvent in the preparation of coating slurries containing catalysts as discussed above may provide the ability to transfer a greater amount of the silver or other catalytic material onto the monolith or other support without significant loss of catalytic material due to dissolution or other chemical interaction between the solvent and the catalyst material. In particular, by comparison to aqueous slurries, the non-reactive nature of IPA may provide benefits such as a reduced dissolution of the catalyst, and also a reduced amount of pore degradation. The use of water has been found to increase the pore size and pore volume.

This property of IPA may also be useful in embodiments where a second catalytic material is included. For example, it is known that catalysts based on a physical mix of 2% silver alumina and Ferrierite can provide for effective NOx conversion at temperatures of interest for exhaust treatment. In one embodiment, a ratio of 4 parts silver alumina to 1 part Ferrierite is used with desirable conversion levels. The two catalysts are each most effective over different portions of the temperature range, and the combination of the two can be used to produce effective NOx conversion across a broader range of temperatures than either can achieve alone.

Although it is possible to produce separate catalytic beds each of which uses only one of the catalytic materials, more successful conversion can be achieved when both catalysts are mixed in a single catalyst bed. Producing such a single-bed mixed-catalyst converter via washcoating is desirably achieved without allowing the preparation and treatment process to chemically or physically degrade one or both of the catalytic materials as they are collectively prepared and washcoated onto the support monolith. In particular, it has been observed that it is desirable to avoid silver ion exchange between the silver-templated alumina and the Ferrierite. Such ion migration of silver into the Ferrierite reduces the catalytic ability of the Ferrierite for hydrocarbon SCR.

Traditional attempts to washcoat the silver-templated alumina/Ferrierite mixture onto a monolith using a water-based slurry resulted in poor performance. Based on the results obtained using isopropyl alcohol in place of water as a solvent in the preparation of the slurry, a slurry was prepared that processed both catalysts simultaneously into a washcoat using IPA in place of water. A 4:1 ratio of silver-templated alumina (400-micron granules) to Ferrierite were mixed together and soaked in IPA for about 16 hours. After this aging, separate granules were observed in the slurry: black granules of silver-templated alumina, and white granules of Ferrierite. This result suggests that the use of IPA avoided migration of silver from the templated alumina substrate to the Ferrierite.

### Example 3

To determine the effectiveness of NOx conversion using this mixed catalyst at varying concentrations in IPA, the following process was performed. GE-9 powder, as described above, at 25 weight percent was mixed into isopropyl alcohol to form a slurry. The slurry was mixed in a 100 mL HDPE Nalgene container until the slurry turned black, which generally took about 20 to about 40 minutes. Ferrierite in various ratios to the silver templated alumina weight was then added to the slurry and the slurry was mixed for 5 additional minutes. This resulting slurry was then washcoated onto a support monolith as described above and then calcined at 550 degrees Celsius for about 4 hours and then tested. A reference monolith was also prepared, which was washcoated with a 4.5% silver-templated alumina slurry that included no Ferrierite. The particular properties of the samples tested in this way are described below:

Test Sample 3-1 was made using GE-9 powder as described above, with isopropyl alcohol as the solvent in the slurry and a 12:1 ratio of GE-9 to Ferrierite. The coated monolith had a catalyst-loading of 132 grams/liter.

Test Sample 3-2 was made in the same way as Sample 3-1, but the ratio of GE-9 to Ferrierite was 8:1 and the catalyst-loading was 133 grams/liter.

Test Sample 3-3 was made in the same way as Sample 3-1, but the ratio of GE-9 to Ferrierite was 6:1 and the catalyst-loading was 131 grams/liter.

Test Sample 3-4 was made in the same way as Sample 3-1, but the ratio of GE-9 to Ferrierite was 4:1 and the catalyst-loading was 151 grams/liter.

Test Sample 3-5 (the reference sample) was made as described for Sample 3-1, but without any Ferrierite, and with 4.5 weight percent GE-9. The catalyst-loading was 130 grams/liter.

The monoliths washcoated with each of these samples were tested using a simulated exhaust stream having 300 parts per million NOx, 1500-1800 ppm C1 from ultra-low-sulfur diesel, 0 ppm sulfur dioxide, 7% water, 9% oxygen (O₂), and 0 ppm hydrogen. The monoliths were tested at exhaust temperatures of 300, 350, 400 and 450 degrees Celsius. The results are shown in Table 3.

TABLE 3
Performance of washcoated monoliths (NOx conversion percentage)

Temperature
(degrees Celsius)

| Sample | 300 | 350 | 400 | 450 |
|---|---|---|---|---|
| Sample 3-1 | 19.9 | 41.2 | 52.2 | 55.2 |
| Sample 3-2 | 16.4 | 34.9 | 49.3 | 58.0 |
| Sample 3-3 | 13.8 | 32.2 | 51.3 | 58.1 |
| Sample 3-4 | 13.4 | 31.5 | 42.1 | 48.3 |
| Sample 3-5 | 6.8 | 24.5 | 33.8 | 36.8 |

Note that the overall conversion ratio among the Ferrierite-containing samples drops with increasing Ferrierite fraction, but that all Ferrierite-containing samples outperform the reference sample which lacks any Ferrierite.

### Example 4

A further test was performed in which alternative zeolites to Ferrierite were considered. The test samples were prepared as described above using a 16:1 ratio of GE-9 to zeolite and five different zeolites. In addition, a reference monolith using the same preparation as Sample 3-5 was included. IPA was used as the solvent for all of these samples. The properties of the samples tested are described below:

Test Sample 4-1 was made using GE-9 powder as described above, with isopropyl alcohol as the solvent in the slurry and a 16:1 ratio of GE-9 to Ferrierite, having a silica to alumina ratio of 20:1. The coated monolith had a catalyst-loading of 175 grams/liter.

Test Sample 4-2 was made using GE-9 powder as described above, with isopropyl alcohol as the solvent in the slurry and a 16:1 ratio of GE-9 to Mordenite, having a silica to alumina ratio of 20:1. The coated monolith had a catalyst-loading of 174 grams/liter.

Test Sample 4-3 was made using GE-9 powder as described above, with isopropyl alcohol as the solvent in the slurry and a 16:1 ratio of GE-9 to Y-zeolite, having a silica to alumina ratio of 5.2:1. The coated monolith had a catalyst-loading of 171 grams/liter.

Test Sample 4-4 was made using GE-9 powder as described above, with isopropyl alcohol as the solvent in the slurry and a 16:1 ratio of GE-9 to Beta-zeolite, having a silica to alumina ratio of 300:1. The coated monolith had a catalyst-loading of 154 grams/liter.

Test Sample 4-5 was made using GE-9 powder as described above, with isopropyl alcohol as the solvent in the slurry and a 16:1 ratio of GE-9 to Beta-zeolite, having a silica to alumina ratio of 38:1. The coated monolith had a catalyst-loading of 151 grams/liter.

Test Sample 4-6 (the reference sample) was made as described for Sample 3-5, having no zeolite at all. The catalyst-loading was 130 grams/liter.

The monoliths washcoated with each of these samples were tested using a simulated exhaust stream having 300 parts per million NOx, 1500-1800 ppm C1 from ultra-low-sulfur diesel, 0 ppm sulfur dioxide, 7% water, 9% oxygen (O₂), and 0 ppm hydrogen. The monoliths were tested at exhaust temperatures of 300, 350, 400 and 450 degrees Celsius. The results are shown in Table 4.

TABLE 4
Performance of washcoated monoliths (NOx conversion percentage)

Temperature
(degrees Celsius)

| Sample | 300 | 350 | 400 | 450 |
|---|---|---|---|---|
| Sample 4-1 | 27.0 | 53.5 | 66.5 | 66.6 |
| Sample 4-2 | 25.2 | 48.1 | 57.3 | 56.4 |
| Sample 4-3 | 13.6 | 29.9 | 32.2 | 42.1 |
| Sample 4-4 | 12.8 | 26.5 | 36.4 | 50.0 |
| Sample 4-5 | 5.9 | 20.4 | 27.9 | 32.0 |
| Sample 4-6 | 6.8 | 24.5 | 33.8 | 36.8 |

Among the tested samples, only Sample 4-2 (Mordenite) has performance comparable to that of Sample 4-1 (Ferrierite).

With regard to any reaction products discussed herein, reference is made to substances, components, or ingredients in existence at the time just before first contacted, formed in situ, blended, or mixed with one or more other substances, components, or ingredients in accordance with the present disclosure. A substance, component or ingredient identified as a reaction product may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product.

All ranges disclosed herein are inclusive of the endpoints, and the endpoints are combinable with each other. The terms “first,” “second,” and the like as used herein do not denote any order, quantity, or importance, but rather are used to distinguish one element from another. The use of the terms “a” and “an” and “the” and similar referents in the context of describing the invention (especially in the context of the following claims) are to be construed to cover both the singular and the plural, unless otherwise indicated herein or contradicted by context.

The various embodiments of methods for coating supports with catalysts and catalyst-coated monoliths described above thus provide a way to achieve an improved NOx conversion in a single bed without degrading the catalyst material during processing. These techniques and systems also allow for multiple catalysts to be combined during processing while minimizing the destructive interaction of the separate catalyst materials during processing.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of isopropyl alcohol as a solvent in slurry preparation described with respect to one embodiment can be adapted for use with a second zeolite catalyst included in the coating slurry described with respect to another. Similarly, the various features described, as well as other known equivalents for each feature, can be mixed and matched by one of ordinary skill in this art to construct additional systems and techniques in accordance with principles of this disclosure.

Although the systems herein have been disclosed in the context of certain preferred embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

What is claimed is:

1. A method for coating a support, comprising:
preparing a precursor slurry by mixing a catalyst precursor, a substrate precursor, a templating agent, and a nonionic surfactant;
spray drying the slurry to form a precursor powder;
calcining the precursor powder in a controlled atmosphere to form a treated powder;
adding a volume of a solvent to the treated powder to form an intermediate slurry;
adding a volume of zeolite to the intermediate slurry to form a coating slurry such that the zeolite remains free of any ion transfer from the catalyst precursor in the slurry;
wetting a support with the coating slurry to coat the support with the coating slurry;
blowing gas over the surface of the support to remove excess coating slurry from the surface of the support and leave a coating of the treated powder on the support;
drying the coated support;
repeating the wetting, blowing and drying steps until a desired thickness quantity of the treated powder has been deposited on the monolith; and
re-calcining the monolith in an oxidizing atmosphere.

2. The method of claim 1, wherein the alcohol is a short-chain alcohol.

3. The method of claim 1, wherein the alcohol is isopropyl alcohol.

4. The method of claim 1, wherein the catalyst precursor is silver.

5. The method of claim 1, wherein the templating agent is ethyl-acetoacetate.

6. The method of claim 1, wherein the substrate precursor is aluminum sec-butoxide.

7. The method of claim 1, wherein the spray drying step is controlled to produce a powder in which at least 90% of the total mass of the powder particles have an effective diameter less than 50 microns.

8. The method of claim 1, wherein at least 90% of the total mass of the powder particles have an effective diameter less than 10 microns.

9. The method of claim 1, wherein the re-calcining step is performed at a temperature of at least about 550 degrees Celsius.

10. The method of claim 1, wherein the re-calcining step is performed at a temperature that does not trigger a change of phase in the substrate precursor.

11. The method of claim 1, wherein the adding a volume of solvent step further comprises waiting until the color of the slurry changes to black before performing the adding a volume of zeolite step.

12. The method of claim 1 wherein the wetting step comprises immersing the support in the coating slurry.

13. The method of claim 1 wherein the support is a monolith.

14. The method of claim 1 wherein the zeolite is Ferrierite.

15. The product formed by the process comprising:
preparing a precursor slurry by mixing a catalyst precursor, a substrate precursor, a templating agent, and a nonionic surfactant;
spray drying the slurry to form a precursor powder;
calcining the precursor powder in a controlled atmosphere to form a treated powder;
adding a volume of a solvent to the treated powder to form an intermediate slurry;
adding a volume of zeolite to the intermediate slurry to form a coating slurry such that the zeolite remains free of any ion transfer from the catalyst precursor in the slurry;
wetting a support with the coating slurry to coat the support with the coating slurry;
blowing gas over the surface of the support to remove excess coating slurry from the surface of the support and leave a coating of the treated powder on the support;
drying the coated support;
repeating the wetting, blowing and drying steps until a desired thickness quantity of the treated powder has been deposited on the monolith; and
re-calcining the monolith in an oxidizing atmosphere

16. The product of claim 15 wherein the catalyst precursor is silver.

17. The product of claim 15 wherein the templating agent is ethyl-acetoacetate.

18. The product of claim 15 wherein the nonionic surface is an octylphenol ethoxylate.

19. The product of claim 15 wherein the nonionic surfactant is (1,1,3,3-Tetramethylbutyl)phenyl-polyethylene glycol.

20. The product of claim 15 wherein the solvent is a short-chain alcohol

21. The product of claim 15 wherein the solvent is isopropyl alcohol.

22. The product of claim 15, wherein the spray drying step is controlled to produce a powder in which at least 90% of the total mass of the powder particles have an effective diameter less than 10 microns.

23. The product of claim 15, wherein the substrate precursor is aluminum sec-butoxide.

24. The product of claim 15, wherein the spray drying step is controlled to produce a powder in which at least 90% of the total mass of the powder particles have an effective diameter less than 50 microns.

25. The product of claim 15, wherein the re-calcining step is performed at a temperature of at least about 550 degrees Celsius.

26. The product of claim 15, wherein the re-calcining step is performed at a temperature that does not trigger a change of phase in the substrate precursor.

27. The product of claim 15, wherein the adding a volume of solvent step further comprises waiting until the color of the slurry changes to black before performing the adding a volume of zeolite step.

28. The product of claim 15 wherein the wetting step comprises immersing the support in the coating slurry.

29. The product of claim 15 wherein the support is a monolith.

30. The product of claim 15 wherein the zeolite is Ferrierite.
